(19) United States
(12) Patent Application Publication
(10) Pub. No.: US 2019/0241465 A1
(43) Pub. Date: Aug. 8, 2019

(54) COATED SUBSTRATE WITH ANTIREFLECTIVE PROPERTIES

(71) Applicant: Tesla, Inc., Palo Alto, CA (US)

(72) Inventor: Christos GOUGOUSSIS, Cupertino, CA (US)

(73) Assignee: Tesla, Inc., Palo Alto, CA (US)

(21) Appl. No.: 16/265,921

(22) Filed: Feb. 1, 2019

Related U.S. Application Data
(60) Provisional application No. 62/625,584, filed on Feb. 2, 2018.

(51) Int. Cl. C03C 17/34; B32B 17/10

(52) U.S. Cl. CPC C03C 17/3452; C03C 17/3417; B32B 17/10036; C03C 2217/734; B32B 2605/006; C03C 2217/213; C03C 2217/212; C03C 2217/285; C03C 2217/218

(57) ABSTRACT

Exemplary antireflective coatings that have antireflective properties for light of non-normal angular incidence are disclosed. An exemplary antireflective coating includes a multilayer having alternating optical layers of high refractive index material and low refractive index material and a second layer directly contacting a first optical layer of the multilayer. The sum of the optical thickness of the second layer and the optical thickness of the first optical layer of the multilayer is between 146 nanometers and 190 nanometers.

### CROSS-REFERENCE TO RELATED APPLICATION

This application claims priority to U.S. Provisional Application No. 62/625,584, filed Feb. 2, 2018, the entire contents of which are hereby incorporated by reference.

### FIELD

The present disclosure generally relates to antireflective coatings, and more specifically to antireflective coatings effective for light of angular incidence.

### BACKGROUND

Many antireflective coatings have satisfactory antireflective properties for light of normal incidence, but have poor antireflective properties for light of non-normal angular incidence, for example, greater than 30 degrees from normal incidence. However, it may be desirable to have an antireflective coating with satisfactory antireflective properties for light of non-normal angular incidence. For example, in an automobile, the light originating from the automobile's dashboard may impinge on a sun roof of the automobile at a non-normal angle of incidence and appear visible to the automobile occupants. As this may be undesirable, e.g., causing distraction to the occupants, it is desired to reduce reflective properties of glass at non-normal angular incidence.

### BRIEF SUMMARY

Exemplary antireflective coatings that have antireflective properties for light of non-normal angular incidence are disclosed. An exemplary antireflective coating includes a multilayer having alternating optical layers of high refractive index material and low refractive index material and a second layer directly contacting a first optical layer of the multilayer. In one example, the sum of the optical thickness of the second layer and the optical thickness of the first optical layer of the multilayer is between 146 nanometers and 190 nanometers

### FIGURES

FIG. 1 shows a cross sectional view of an exemplary glass panel including an antireflective coating.

FIG. 2 shows a cross sectional view of an exemplary antireflective coating in accordance with some examples.

FIG. 3 shows a cross sectional view of an exemplary antireflective coating in accordance with some examples.

FIG. 4 shows various examples of coatings.

### DETAILED DESCRIPTION

The following description is presented to enable a person of ordinary skill in the art to make and use the various embodiments. Descriptions of specific systems, devices, methods, and applications are provided only as examples. Various modifications to the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown, but are to be accorded the scope consistent with the claims.

FIG. 1 shows a cross-sectional view of exemplary glass panel 100. In this example, glass panel 100 includes an anti-reflective coating 102 disposed on a substrate layer 104 and/or on glass structure 106. Glass structure 106 includes various materials and structures known in the art for use in automobile glass, e.g., PVB layer 108, PET interlayer 110, PVB layer 112, and/or soda lime glass layer 114. As described in greater detail below, coating 102 provides antireflective properties at non-normal angles of incidence.

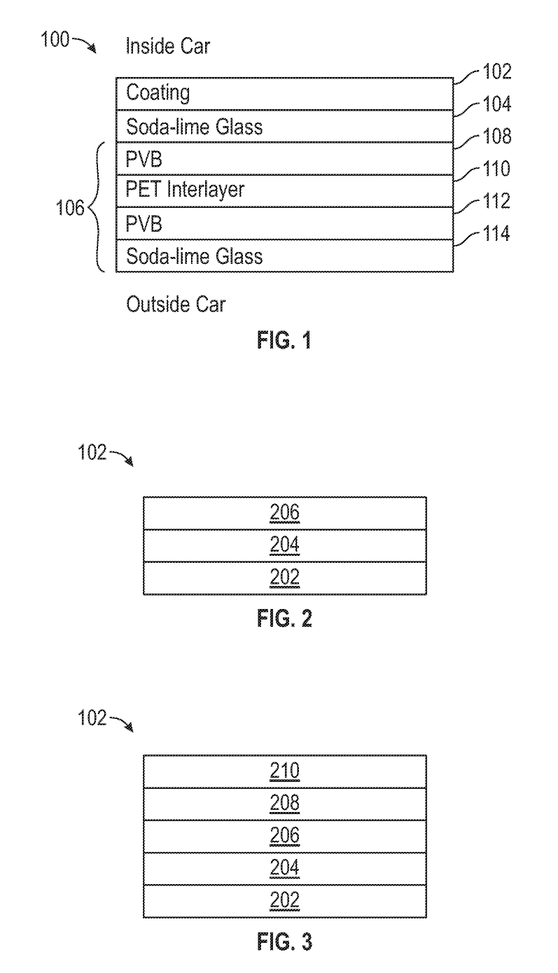

Coating 102 may include two or more optical layers as described in greater detail below with respect to FIGS. 2 and 3. As used herein, an “optical layer” describes a block having one or more materials, wherein the respective refractive index of each material of the one or more materials differs from the respective refractive index of every other material of the one or more materials by less than 0.2. Thus in some examples, an optical layer includes multiple layers of different materials.

Each optical layer of the two or more optical layers of coating 102 may include an oxide, a fluoride, a nitride, or any material containing at least 80% in mass of any one of the aforementioned materials. For example, a first optical layer of the two of more optical layers may include a first material, where silicon nitride forms at least 80% of the first material mass and where aluminum forms less than 20% of the first material mass. The thickness of each optical layer of the two or more optical layers of coating 102 may be less than or equal to 200 nanometers.

Exemplary oxides that may be included in one or more optical layers of the two or more optical layers of coating 102 include SiO₂, TiO₂, Nb₂O₅, Al₂O₃, SnO₂, ITO, ZrO₂, ZnO, SnZnO, In₂O₃, and CeO₂. Exemplary fluorides that may be included in one or more optical layers of the two or more optical layers include MgF₂ and CaF₂. Exemplary nitrides that may be included in one or more optical layers of the two or more optical layers include Si₃N₄, AIN, NbN, SiZrN, and TiN.

The two or more optical layers of coating 102 may alternate between high refractive index optical layers and low refractive index optical layers. In other words, for any two directly contacting optical layers of coating 102, the refractive index of one optical layer of the two optical layers may be high, and the refractive index of the other optical layer of the two optical layers may be low. As used herein, a low refractive index refers to a refractive index between 1.2 and 1.8, and a high refractive index refers to a refractive index greater than 1.8.

Glass panel 100 may be bent into a curved shape, may be decorated with frit, or may be encapsulated in another material. Such bending, decoration, and/or encapsulation of glass panel 100 may make glass panel 100 suitable for use in motor vehicles.

The optical properties and additional structural properties of coating 102 are now discussed with respect to FIGS. 2 and 3.

FIG. 2 shows an exemplary cross sectional view of coating 102. As shown, in some examples, coating 102 includes a substrate 202 coated with a first multilayer (e.g., a block including more than one optical layer) 204 that is coated with a second layer 206.

FIG. 3 shows an exemplary cross sectional view of coating 102 where coating includes third layer 208 and/or fourth layer 210 in addition to first multilayer 204 and/or second layer 205. Third layer 208 may coat second layer 206. In other examples, third layer 208 may coat first multilayer 204. Third layer 208 may include one or more sheets of a transparent conductive material such as ITO. By including third layer 208, the emissivity of coating 102 may be reduced, thus reducing the heat transfer caused by light reflecting off coating 102.

The one or more sheets of third layer 208 may include small scale structures with a characteristic length of a few microns. The small scale structures may allow coating 102 to be transmissive to electromagnetic signals of frequencies typically emitted by communication devices (e.g., GPS devices, mobile phones, laptops, and vehicle consoles.)

In some examples, coating 102 may include fourth layer 210. As shown in FIG. 3, fourth layer 210 may coat third layer 208. In other examples, fourth layer 210 may coat second layer 206 or first multilayer 204. Fourth layer 210 may include one or more materials with anti-scratch, hydrophobic, or anti-static properties.

First multilayer 204 may include alternating optical layers of high refractive index material and low refractive index material. Second layer 206 may be a protective layer, and may include a single layer with a thickness of less than 15 nm. In other examples, second layer 206 may include multiple layers.

Coating 102 may have a top layer optical thickness. As used herein, the optical thickness, OT(X) of a layer X with a refractive index n and thickness t is OT(X)=n t. If a layer includes two or more different materials with respective refracting indices differing by less than 0.2 (e.g., the layer is an optical layer), then the refractive index n of the layer is the average refractive index of all the materials that form the layer.

In examples where coating includes first multilayer 204 and does not include second layer 206, the top layer of coating 102 may be an optical layer of first multilayer 204 that only directly contacts one other optical layer of first multilayer 204 and does not directly contact substrate 202. Accordingly, the top layer optical thickness may be the thickness of the top optical layer of coating 102 multiplied by the refractive index of the top optical layer.

In examples where coating 102 includes first multilayer 204 and a second layer 206 with a thickness of less than 15 nm, the top layer optical thickness of coating 102 may be the sum of the optical thickness of a first optical layer of first multilayer 204 that directly contacts second layer 206 and the optical thickness of the second layer 206. For example, first multilayer 204 may include a 50 nm thick optical layer of Si₃N₄ and a 60 nm thick optical layer of SiO₂, and second layer 206 may include a 5 nm thick layer of SnZNO that directly contacts the 60 nm thick optical layer of SiO₂. In this example, the top layer optical thickness of coating 102 is t_{SiO2}*n_{SiO2}+t_{SnZnO}*n_{SnZnO}=60*1.45+5*2=103.6 nm.

In some examples, the first optical layer of multilayer 204 that directly contacts second layer 206 may have a refractive index of less than 1.7 for light of 550 nm. In some examples where coating 102 does not include second layer 206, an optical layer of first multilayer 204 that only directly contacts one other optical layer of first multilayer 204 and does not directly contact substrate 202 may have a refractive index of less than 1.7 for light of 550 nm.

The top layer optical thickness of coating 102 may be between 146 nm and 190 nm. A coating with a top layer optical thickness between 146 nm and 190 nm may have unexpected advantages and results. For example, coating 102 may have a visible reflectance for light of 60 degree angular incidence (Rᵥᵢₛ₆₀) of less than 3.5%. In contrast, typical anti-reflective coatings that are not optimized to have anti-reflective properties for light of non-normal incidence may have Rᵥᵢₛ₆₀ greater than 4%. The visible reflectance may be defined according to the ISO9050 standard.

Examples of coating 102 discussed above may have antireflective properties for light of normal incidence. For example, coating 102 may have a reflectance for light of normal incidence (Ro) of less than 3%. Accordingly, examples of coating 102 discussed above may have antireflective properties for light of angular incidence (e.g., 50-70 degree incidence) in addition to having antireflective properties for light of normal incidence.

Examples of coating 102 discussed above may have a neutral color at all viewing angles. In particular, the a* value and the b* value for the examples of coating 102 discussed above may respectively be between −10 and 5 and −15 and 5 for angles of incidence ranging from normal incidence (0 degrees) to 60 degrees incidence. The a* value and the b* value of coating 102 may be measured according to the CIE 1931 standard.

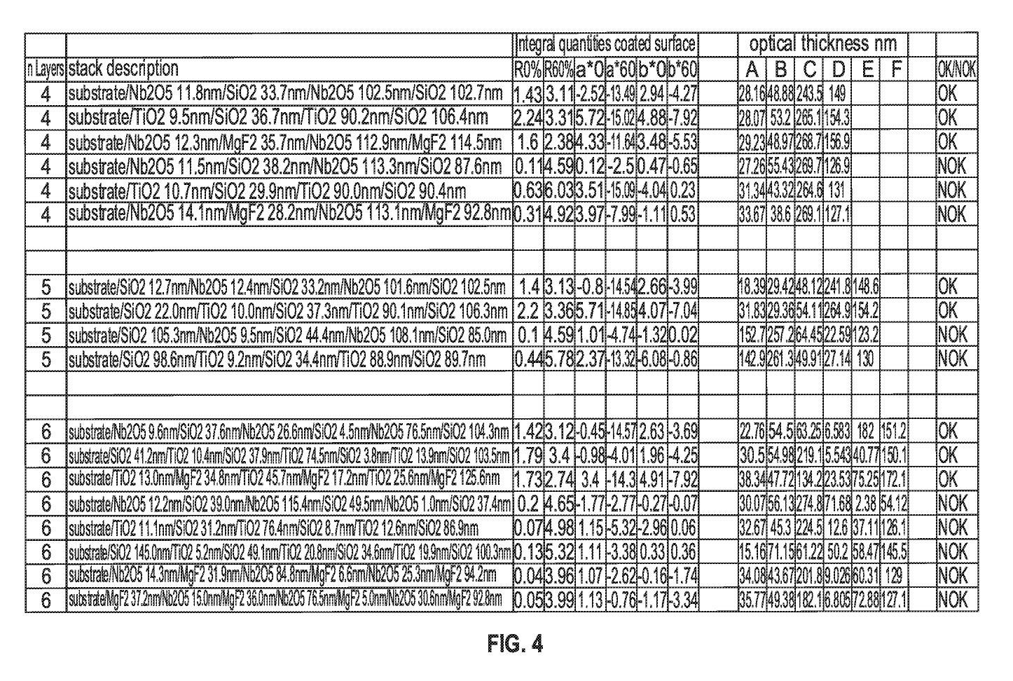

FIG. 4 shows various examples of coatings (e.g., coating 102). The normal reflectance percentage R₀ of the coatings, the visible reflectance percentage of the coatings at 60 degrees Rᵥᵢₛ₆₀, the a* value of the coatings at normal incidence and at 60 degree incidence, the b* value of the coatings at normal incidence and at 60 degree incidence, the optical thickness of the various layers that form the coatings, and whether the coatings have an acceptable visible reflectance for light of 60 degree incidence are calculated. Acceptable visible reflectances for light of 60 degree incidence may be less than 3.5%. The substrate in FIG. 4 is soda-lime glass, and the reflectance is measured from the light reflected from the coated side of the substrate.

As shown in FIG. 4, an important parameter in determining whether a coating has an acceptable visible reflectance for light of 60 degree incidence may be the top layer optical thickness of the coating (e.g., column D for n=4 layers, column E for n=5 layers, and column F for n=6 layers). In particular, coatings with top layer optical thicknesses between 146 nm and 190 nm may have acceptable visible reflectance for light of 60 degree incidence.

The foregoing description, for purpose of explanation, has been described with reference to specific examples. However, the illustrative discussions above are not intended to be exhaustive or to limit the invention to the precise forms disclosed. Many modifications and variations are possible in view of the above teachings. The examples were chosen and described in order to best explain the principles of the invention and its practical applications, to thereby enable others skilled in the art to best utilize the invention and various examples with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

What is claimed is:

1. An antireflective coating for use with a substrate, the antireflective coating comprising:
a multilayer comprising alternating optical layers of high refractive index material and low refractive index material; and
a second layer directly contacting a first optical layer of the multilayer, wherein the sum of an optical thickness of the second layer and an optical thickness of the first optical layer of the multilayer is between 146 nanometers and 190 nanometers.

2. The antireflective coating of claim 1, wherein a thickness of the second layer is less than 15 nanometers.

3. The antireflective coating of claim 1, wherein the second layer is not an optical layer of the multilayer.

4. The antireflective coating of claim 1, wherein a visible reflectance of light of 60 degree angular incidence on the antireflective coating is less than 3.5%.

5. The antireflective coating of claim 1, wherein a reflectance of light of normal incidence on the antireflective coating is less than 3%.

6. The antireflective coating of claim 1, wherein the a* value and the b* value of the antireflective coating are respectively between −10 and 5 and −15 and 5 for light ranging from normal incidence to 60 degrees incidence on the antireflective coating.
